(19) United States
(12) Patent Application Publication
(10) Pub. No.: US 2010/0185945 A1
(43) Pub. Date: Jul. 22, 2010

(54) OPERATION CONTROL APPARATUS AND METHOD FOR CONTROLLING DEVICE THROUGH WIND RECOGNITION

(75) Inventor: Hea Jin Yang, Seoul (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/556,351

(22) Filed: Sep. 9, 2009

(30) Foreign Application Priority Data
Jan. 22, 2009 (KR) 10-2009-0005377

(51) Int. Cl. G06F 3/01

(52) U.S. Cl. 715/700

(57) ABSTRACT

An operation control apparatus can control a device through wind recognition. The apparatus includes a sensor unit to sense inputted wind and to generate waveform data with respect to the wind, a waveform comparison unit to determine strength and/or direction of the wind based on the waveform data, and a processing unit to perform an operation using the strength or direction of the wind. The processing unit may generate interactive data using the strength or direction of the wind, and transmits the interactive data to another mobile terminal during a voice call or video call. The interactive data may be displayed on a mobile terminal, and may change according to a change in the detected characteristics of the wind.

### CROSS-REFERENCE TO RELATED APPLICATION

This application claims priority from and the benefit of Korean Patent Application No. 10-2009-0005377, filed on Jan. 22, 2009, which is hereby incorporated by reference for all purposes as if fully set forth herein.

### BACKGROUND OF THE INVENTION

1. Field of the Invention

The present invention relates to a method for controlling the operation of a device through wind recognition, and an operation control apparatus to control the operation of a device through wind recognition.

2. Discussion of the Background

Recently, research to enhance a video call function in a Wideband Code Division Multiple Access (WCDMA) mobile device has been conducted. One such development includes a data transmission method using a touch screen.

However, a data transmission method using a touch screen requires the terminal to include a component for receiving the touch, and this may cause an increase in manufacturing costs. Accordingly, a data transmission method using a touch screen may have some limited applicability since some devices are not manufactured with a touch screen.

Conversely, a data transmission method using a keypad may be inconvenient to a user who is not familiar with using a keypad for operations other than dialing a telephone, and this may cause some user inconvenience. Accordingly, representing intuitive emotion using a text may be limited.

Also, some users prefer to represent their emotions or personalities by configuring an idle display of their mobile phones. A still image may be displayed on a standby screen, and a video may be implemented by using a Flash program. However, the video may not be interactive with a user.

### SUMMARY OF THE INVENTION

Exemplary embodiments of the present invention provide an operation control apparatus and method for controlling operation of a device through wind recognition, including performing an operation in response to detecting a characteristic of the wind during a telephone call, such as an operation of transmitting data to a second device.

Exemplary embodiments of the present invention provide an operation control apparatus and method for controlling operation of a device through wind recognition where the inputted wind is inputted to a microphone arranged in a terminal.

Exemplary embodiments of the present invention provide an operation control apparatus and method for controlling operation of a device through wind recognition such that a wind input may be received as a User Interface (UI) to perform a command or operation in a menu, or with respect to a standby screen displaying an image that changes according to the wind input.

Additional aspects of the invention will be set forth in the description which follows, and in part will be apparent from the description, or may be learned by practice of the invention.

An exemplary embodiment of the present invention discloses an operation control apparatus, including a sensor unit to sense wind inputted to a first mobile terminal, and to generate waveform data corresponding to the wind; a waveform comparison unit to determine at least one of a strength and a direction of the wind based on the waveform data; and a processing unit to perform an operation using at least one of the strength and the direction of the wind.

An exemplary embodiment of the present invention discloses a method controlling an operation of a first mobile terminal through wind recognition. The method includes sensing wind inputted to the first mobile terminal; generating waveform data corresponding to the wind; determining at least one of a strength and a direction of the wind based on the waveform data; and performing an operation using at least one of the strength and the direction of the wind.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram illustrating a configuration of an operation control apparatus through wind recognition according to an exemplary embodiment of the present invention.

FIG. 2 and FIG. 3 are diagrams illustrating an example of transmitting and displaying interactive data according to an exemplary embodiment of the present invention.

FIG. 4 is a diagram illustrating a User Interface (UI) according to an exemplary embodiment of the present invention.

FIG. 5 is a flowchart illustrating an operation control method through wind recognition according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

An operation control apparatus through wind recognition according to an exemplary embodiment of the present invention may transmit interactive data to another terminal, or constitute a User Interface (UI).

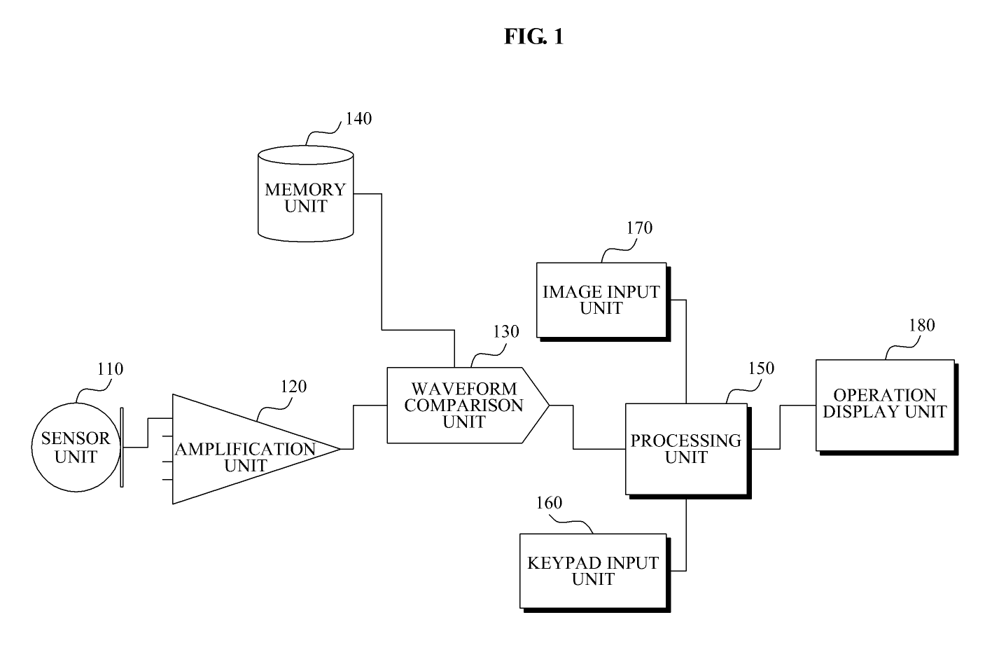

FIG. 1 is a block diagram illustrating a configuration of an operation control apparatus through wind recognition according to an exemplary embodiment of the present invention. Hereinafter, an operation control apparatus through wind recognition will be referred to as an ‘operation control apparatus.’ The operation control apparatus may be arranged in a first mobile terminal such as a mobile phone, and FIG. 1 will be described as such, although this description is not intended to limit the operation control apparatus.

Referring to FIG. 1, the operation control apparatus may include a sensor unit 110, an amplification unit 120, a waveform comparison unit 130, a memory unit 140, a processing unit 150, a keypad input unit 160, an image input unit 170, and an operation display unit 180.

The sensor unit 110 may sense wind inputted to the first mobile terminal, and may generate waveform data with respect to the sensed wind. The wind may be generated by ambient conditions, or a user may generate the wind by blowing air toward the sensor unit 110. In this instance, the sensor unit 110 may include a microphone arranged in the first mobile terminal, and the waveform data generated by the sensor unit 110 may be analog data. Also, the sensor unit 110 or a separate component of the operation control apparatus may generate digital waveform data by converting the analog waveform data to digital waveform data.

For example, if a user blows into the microphone of the first mobile terminal, the sensor unit 110 may receive and sense the wind, and generate the analog waveform data with respect to the sensed wind. Also, the sensor unit 110 may output the digital waveform data by converting the analog waveform data, or may send the analog waveform data to a separate analog-to-digital converter (not shown) to convert the analog waveform data to digital waveform data.

The amplification unit 120 may amplify and output the digital waveform data.

The waveform comparison unit 130 may analyze the amplified waveform data, and determine wind existence, strength, direction, and other characteristics. For this, the waveform comparison unit 130 may determine the wind's presence, strength, and direction by referring to the memory unit 140. Here, the memory unit 140 may sort the waveform data based on the presence, the strength, and the direction of the wind, and record the sorted waveform data.

That is, the waveform comparison unit 130 may compare a characteristic of the waveform data stored in the memory unit 140 with a characteristic of the amplified waveform data, retrieve waveform data similar or most identical to the amplified waveform data, and determine the presence, the strength, and the direction of the wind. Here, the characteristic of the waveform data stored in the memory unit 140 may be a level, a period, and/or an amplitude of wind.

Also, the memory unit 140 may record and maintain waveform data of a particular wind as reference data. In this instance, the waveform comparison unit 130 may determine the presence, the strength, and the direction of the wind sensed by the sensor unit 110 by comparing that waveform data with the reference data stored in the memory unit 140.

That is, the waveform comparison unit 130 may respectively compare an amplitude, a period, and the like of the waveform data generated by the sensor unit 110 with an amplitude, a period, and the like of the reference data stored in the memory unit 140, and thereby may determine the presence, the strength, and the direction of the wind.

The processing unit 150 may generate interactive data using the presence, the strength, and the direction of the wind. That is, the processing unit 150 may generate interactive data in proportion to or corresponding to the determined strength or direction of the wind in various conditions. Also, the processing unit 150 may provide movement or changes to the interactive data based on the determined direction or strength.

For example, if a strength of the wind sensed by the sensor unit 110 is weaker, the processing unit 150 may generate a single heart image as the interactive data. If a strength of the wind sensed by the sensor unit 110 is stronger, the processing unit 150 may generate multiple heart images as the interactive data. Similarly, the processing unit 150 may generate one or more heart images having a size corresponding to the strength of the wind. Further, if a direction of the wind is detected as moving from left-to-right, the processing unit 150 may generate and display the heart image moving from left to right. If a direction of the wind is detected as moving from right-to-left, the processing unit 150 may generate and display the heart image moving from right to left.

For another example, the processing unit 150 may generate an image, which will be referred to as interactive data, on a screen of the first mobile terminal, such as in a video call area of the first mobile terminal, using the wind recognized by the sensor unit 110. For this, the processing unit 150 may generate a predetermined image depending on the presence, the strength, and/or the direction of the wind sensed by the sensor unit 110, and actively display the generated image on the video call area.

The processing unit 150 may change the generated interactive data according to a change of the strength and/or the direction of the wind.

For example, the processing unit 150 may adjust a number of pieces of interactive data to be generated according to a change of at least one of the strength and the direction of the wind. If a strength of the wind recognized by the sensor unit 110 changes from ‘weak’ to ‘strong’, the processing unit 150 may change a single heart image to multiple heart images, or may increase the size of one or more heart images.

For another example, the processing unit 150 may move or change a display location of the generated interactive data according to the change of the strength and/or the direction of the wind. If a source direction of the wind changes from ‘right’ to ‘left’, the processing unit 150 may change a movement direction of the heart image to correspond to the new wind direction.

The processing unit 150 may transmit the generated interactive data to a second mobile terminal. The operation display unit 180 may display the generated interactive data to the video call area of the first mobile terminal substantially simultaneously or with an inconsequential time difference after the wind is inputted or after a change in the wind conditions are determined.

Also, the processing unit 150 may constitute a UI using the presence, the strength, and the direction of the wind.

For example, the processing unit 150 may constitute the UI to permit a menu or function to be selected depending on the sensed wind. Accordingly, a user may select the menu such as a Digital Multimedia Broadcasting (DMB), a camera, a message, and the like, or may select an item within a menu or list (such as a song list, picture list, or video list), by blowing through the microphone of the first mobile terminal.

For another example, the processing unit 150 may constitute the UI to enable menus to move according to the change of at least one of the strength and the direction of the wind.

As an example, the processing unit 150 may control a menu to be displayed through the UI depending on the strength of the wind. Accordingly, the DMB menu may be selected if the wind is weaker, the camera menu may be selected if the wind is intermediate strength, and the message menu may be selected if the wind is stronger. Thus, a user may select a corresponding menu by adjusting the strength of the wind through the sensor unit 110 of the first mobile terminal.

Also, the processing unit 150 may constitute the UI to permit a movement direction of menus to be selected depending on the determined direction of the wind. Accordingly, the user may select the movement direction (left, right, top, and bottom) of menus such as the DMB, the camera, the message, and the like, by adjusting the direction of the wind.

For another example, the processing unit 150 may change the constituted UI according to the change of the strength and the direction of the wind. For purpose of example, it may be assumed that an image of a lighted candle is displayed on an idle screen of the first mobile terminal. If the strength of the wind sensed by the sensor unit 220 is weaker, the processing unit 150 may change the UI of the standby screen to an image where the candle flame slightly flickers. If the strength of the wind sensed by the sensor unit 220 increases, the processing unit 150 may change the UI of the standby screen to a dark image where a candle flame is extinguished.

Also, if the direction of the wind moves from left-to-right, the processing unit 150 may change the UI of the standby screen to an image where the candle flame flickers to the right. If the direction of the wind moves from right-to-left, the processing unit 150 may change the UI of the standby screen to an image where the candle flame flickers to the left.

The processing unit 150 may receive input data from the keypad input unit 160 and the image input unit 170 depending on an UI environment, or may transmit the input data to the operation display unit 180 in response to a user's action.

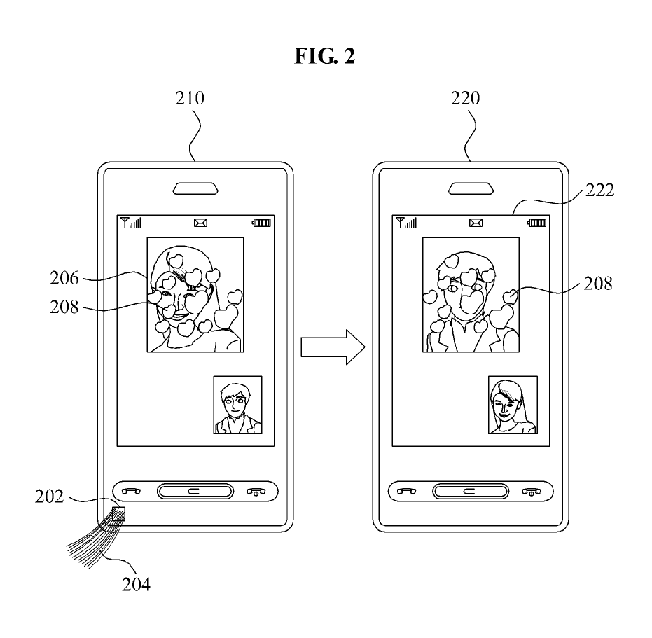

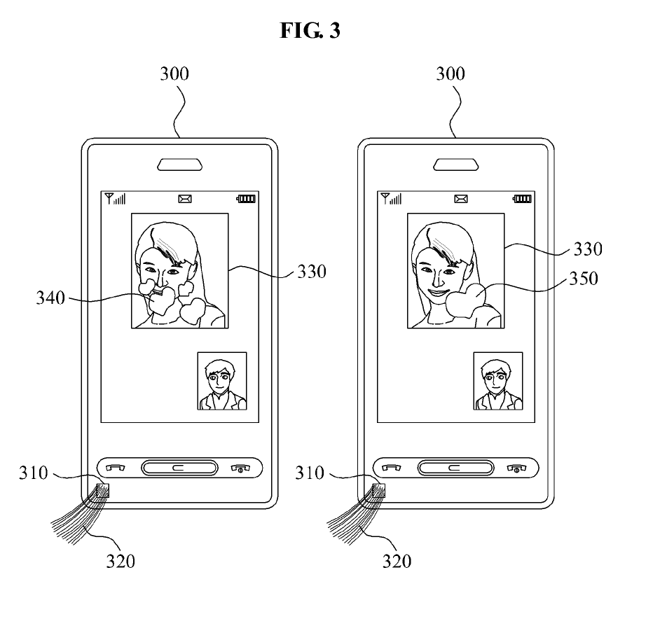

FIG. 2 and FIG. 3 are diagrams illustrating an example of transmitting and displaying interactive data according to an exemplary embodiment of the present invention.

As illustrated in FIG. 2, an operation control apparatus may display heart images 208 on a video call area 206 in response to wind 204 inputted through a microphone 202 of a first mobile terminal 210. In this instance, the operation control apparatus may adjust the number and/or size of heart images 208 generated in proportion to the strength of the wind 204. That is, the operation control apparatus may display a greater number of heart images 208 or larger heart images on the video call area 206 as the strength of the wind 204 increases.

Also, the operation control apparatus may transmit the heart images 208 to a second mobile terminal 220, either during a video call or during a voice call or through a separate data transmission such as multimedia messaging service (MMS). Accordingly, the second mobile terminal 220 may receive the heart images 208 from the first mobile terminal 210, and display the heart images 208 on a video call area 222.

As illustrated in FIG. 3, if a stronger wind 320 is inputted through a microphone 310 of a first mobile terminal 300, the operation control apparatus may display multiple heart images 340 on a video call area 330. Conversely, if a weaker wind 320 is inputted to the microphone 310, the operation control apparatus may display a single heart image 350 on the video call area 330. Thus, the quantity of interactive data generated may depend upon strength of the wind inputted to the microphone 310.

As described above, the operation control apparatus may transmit the interactive data during a video or telephone call, and therefore better reflect a user's emotion in the data through wind recognition. Also, the operation control apparatus may provide improved convenience through wind recognition, instead of a more complex input such as through a keypad. Also, the operation control apparatus may be incorporated into a first mobile terminal with low or no additional cost if the first mobile terminal includes a microphone.

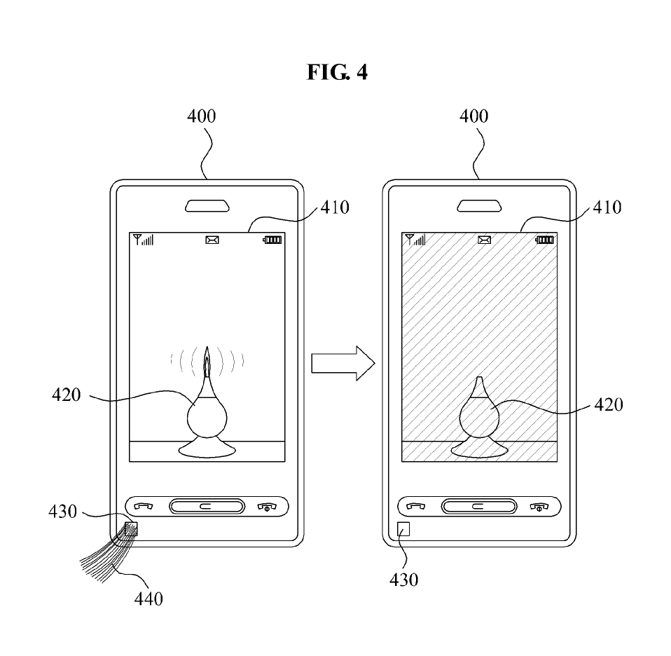

FIG. 4 is a diagram illustrating an UI according to an exemplary embodiment of the present invention.

As illustrated in FIG. 4, the operation control apparatus may display an image 420 of a lighted candle on a standby screen 410 of a first mobile terminal 400 to constitute the UI of the standby screen 410. In this instance, if a sufficiently strong wind 440 is inputted to the microphone 430, the operation control apparatus may reconstitute the UI of the standby screen 410 by displaying a dark image where the image 420 of the candle flame is extinguished on the standby screen 410.

Also, if a direction of the wind 440, inputted through a microphone 430 of the operation control apparatus, moves from left-to-right, the operation control apparatus may constitute the UI of the standby screen 410 by displaying an image where the image 420 of the candle flame flickers to the right on the standby screen 410. If the direction of the wind 440 moves from right-to-left, the operation control apparatus may change the UI of the standby screen 410 by displaying an image where the image 420 of the candle flame flickers to the left.

As described above, the operation control apparatus may provide a standby screen or a game with an entertainment element through an UI using wind recognition. Also, the operation control apparatus may provide an interactive and emotional response that may reflect a current emotion trend by the user of a first mobile terminal such as a mobile phone.

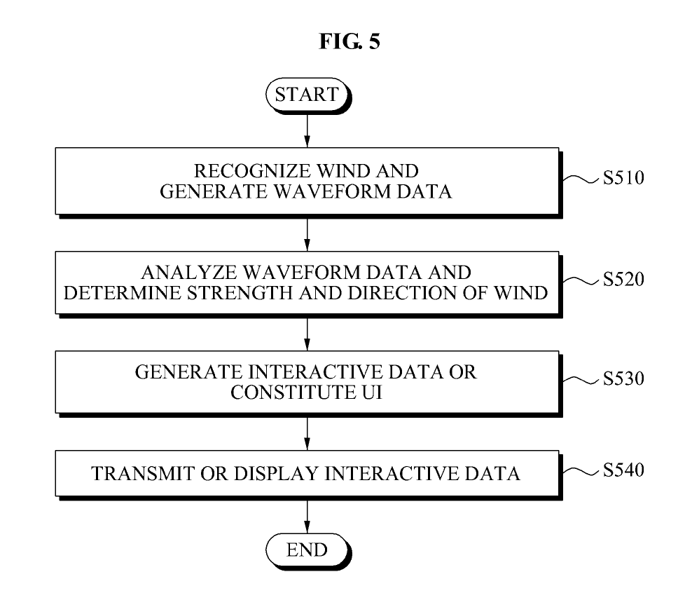

FIG. 5 is a flowchart illustrating an operation control method through wind recognition according to an exemplary embodiment of the present invention. Here, the operation control method through wind recognition will described as if performed by the operation control apparatus of FIG. 1.

Referring to FIG. 5, in operation S510, the operation control apparatus may recognize or sense inputted wind, and generate waveform data with respect to the recognized wind. In this instance, the operation control apparatus may include a microphone arranged in a first mobile terminal. The operation control apparatus may recognize wind inputted through the microphone, and generate analog waveform data.

Subsequently, the operation control apparatus may convert the analog waveform data into digital waveform data, and amplify and output the generated digital waveform data.

In operation S520, the operation control apparatus may analyze the amplified waveform data, and determine characteristics such as wind presence, strength, and direction.

For this, the operation control apparatus may determine the presence, the strength, and the direction of the wind by referring to a memory unit 140 of FIG. 1 that may sort the waveform data based on the presence, the strength, and the direction of the wind, and record the sorted waveform data.

That is, the operation control apparatus may compare a characteristic of the waveform data stored in the memory unit with a characteristic of the amplified waveform data, retrieve waveform data identical to the amplified waveform data, and determine the presence, the strength and the direction of the wind. Here, the characteristic may be a level, a period, and/or an amplitude of the wind.

Also, the operation control apparatus may record and maintain waveform data of a particular wind as reference data in the memory unit. In this instance, the operation control apparatus may determine the existence, the strength and the direction of the wind using the reference data stored in the memory unit.

That is, the operation control apparatus may respectively compare an amplitude, a period, and the like of the amplified waveform data with an amplitude, a period, and the like of the reference data stored in the memory unit 140, and thereby may determine the presence, the strength and the direction of the wind.

In operation S530, the operation control apparatus may generate interactive data using the presence, the strength, and the direction of the wind, or may constitute the UI. Hereinafter, an operation of generating the interactive data and an operation of constituting the UI are described in more detail.

The operation of generating the interactive data is described as follows.

The operation control apparatus may generate interactive data in proportion to the determined strength of the wind in various conditions. Also, the operation control apparatus may change or move the interactive data based on a change in the determined wind direction or strength.

For example, if wind strength is weaker, the operation control apparatus may generate a single heart image as the interactive data. If wind strength is stronger, the operation control apparatus may generate multiple heart images as the interactive data. If a wind direction moves from left-to-right, the operation control apparatus may generate the heart image moving to the right. If wind direction moves from right-to-left, the operation control apparatus may generate the heart image moving to the left.

The operation control apparatus may change the generated interactive data according to a change of the strength and/or the direction of the wind. For example, if the wind strength increases, the operation control apparatus may generate an increased number of heart images as the interactive data, and may change a single heart image to multiple heart images.

Similarly, if the wind direction changes from ‘right’ to ‘left’, the operation control apparatus may generate the heart image moving to the left, and change a movement direction of the displayed heart image from the right to the left.

The operation of constituting the UI is described in more detail.

The operation control apparatus may constitute the UI using the determined presence, the strength, and the direction of the wind. For example, the operation control apparatus may constitute the UI to select a menu depending on the determination concerning presence of the wind. Accordingly, a user may select the menu such as a DMB function, a camera, a message, and the like, by blowing air into the microphone of the first mobile terminal.

For another example, the operation control apparatus may constitute the UI to select different menus according to the determined strength of the wind. Accordingly, the user may change a selection of the menus such as the DMB, the camera, the message, and the like, by adjusting the strength of the wind through the microphone of the first mobile terminal.

For another example, the operation control apparatus may constitute the UI to select a movement direction of the menus depending on the determined direction of the wind. Accordingly, the user may select the movement direction (left, right, top, and bottom) of the menus such as the DMB, the camera, the message, and the like, by adjusting the input direction of the wind into the microphone of the first mobile terminal.

The operation control apparatus may change the constituted UI according to the change of the strength and the direction of the wind. If an image of a lighted candle is displayed on a standby screen of the first mobile terminal, and the strength of the wind is weaker, the operation control apparatus may change the UI of the standby screen to an image where a candle flame slightly flickers. If the strength of the wind is increased, the operation control apparatus may change the UI of the standby screen to a dark image where a candle flame is extinguished.

Also, if the direction of the wind is left-to-right, the operation control apparatus may change the UI of the standby screen to an image where the candle flame flickers to the right. If the direction of the wind is right-to-left, the operation control apparatus may change the UI of the standby screen to an image where the candle flame flickers to the left.

In operation S540, the operation control apparatus may transmit the generated interactive data to a second mobile terminal, or display the generated interactive data on a video call area of the first mobile terminal. The operation control apparatus may perform the operation of transmitting and the operation of displaying substantially simultaneously, such as with an inconsequential time difference during a video call or voice call with the second mobile terminal, or by a multimedia messaging service (MMS) message to the second mobile terminal.

The above-described embodiments of the present invention may be recorded in computer-readable media including program instructions to implement various operations when executed by a computer. The media may also include, alone or in combination with the program instructions, data files, data structures, and the like. Examples of computer-readable media include magnetic media such as hard disks, floppy disks, and magnetic tape; optical media such as CD-ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. An operation control apparatus, comprising:
a sensor unit to sense wind inputted to a first mobile terminal, and to generate waveform data corresponding to the wind;
a waveform comparison unit to determine at least one of a strength and a direction of the wind based on the waveform data; and
a processing unit to perform an operation using at least one of the strength and the direction of the wind.

2. The operation control apparatus of claim 1, wherein the processing unit generates interactive data using at least one of the strength and the direction of the wind, and transmits the interactive data to a second mobile terminal.

3. The operation control apparatus of claim 2, wherein the processing unit comprises an operation display unit to display the interactive data on a call area in a screen of the first mobile terminal.

4. The operation control apparatus of claim 2, wherein if there is a change in at least one of the strength and the direction of the wind inputted to the first mobile device, the processing unit adjusts a number of pieces of interactive data to be generated according to the change.

5. The operation control apparatus of claim 2, wherein if there is a change in at least one of the strength and the direction of the wind inputted to the first mobile device, the processing unit changes a display location of the interactive data according to the change.

6. The operation control apparatus of claim 1, wherein the sensor unit senses the wind inputted to a microphone arranged in the first mobile terminal, and generates the waveform data.

7. A method controlling an operation of a first mobile terminal through wind recognition, comprising:
sensing wind inputted to the first mobile terminal;
generating waveform data corresponding to the wind;
determining at least one of a strength and a direction of the wind based on the waveform data; and
performing an operation using at least one of the strength and the direction of the wind.

8. The operation control method of claim 7, wherein performing the operation comprises:
generating interactive data using at least one of the strength and the direction of the wind; and
transmitting the interactive data to a second mobile terminal.

9. The operation control method of claim 8, wherein performing the operation comprises:
displaying the interactive data on a call area in a screen of the first mobile terminal.

10. The operation control method of claim 8, wherein performing the operation further comprises:
determining a change in at least one of the strength and the direction of the wind; and
adjusting a number of pieces of interactive data to be generated according to the change.

11. The operation control method of claim 8, wherein performing the operation further comprises:
determining a change in at least one of the strength and the direction of the wind; and
changing a display location of the interactive data according to the change.

12. The operation control method of claim 7 wherein performing the operation further comprises:
constituting a User Interface (UI) in a screen of the first mobile terminal using at least one of the strength and the direction of the wind.

13. The operation control method of claim 12, wherein performing the operation further comprises:
determining a change in at least one of the strength and the direction of the wind; and
changing the UI according to the change.

14. The operation control method of claim 7, wherein generating waveform data comprises:
sensing the wind inputted into a microphone arranged in the first mobile terminal, and generating the waveform data.

15. A computer comprising a processor and a computer-readable recording medium storing a program for implementing a method for controlling operation of a first mobile terminal through wind recognition when executed, the method comprising:
sensing wind inputted to the first mobile terminal;
generating waveform data corresponding to the wind;
determining at least one of a strength and a direction of the wind based on the waveform data; and
performing an operation using at least one of the strength and the direction of the wind.
